(19) United States
(12) Patent Application Publication
(10) Pub. No.: US 2011/0087764 A1
(43) Pub. Date: Apr. 14, 2011

(54) ENGINE FOR GENERATING AND MANAGING COMMUNICATIONS CONCERNING ON-LINE COLLABORATION AMONG A PLURALITY OF USERS IN CONSIDERATION WITH A COMPUTERIZED APPLICATION

(76) Inventors: DROR YAFFE, Tel Aviv (IL); GILAD COHEN, Tel Aviv (IL)

(21) Appl. No.: 12/903,759

(22) Filed: Oct. 13, 2010

Related U.S. Application Data
(60) Provisional application No. 61/272,625, filed on Oct. 14, 2009.

(51) Int. Cl. G06F 15/173

(52) U.S. Cl. 709/223

(57) ABSTRACT

System for generating and managing communication accomplished by means of graphical layers is provided. The graphical layers may comprise graphical features, text pictures and computerized objects such as media player for displaying a selected film, The system enables a user to call one or more of her or his colleagues to on-line collaborate in consideration with a selected content. The system provides a user for generating a new graphical layer, adding or deleting user generated content (UGC) into, or off a graphical layer generated by another user. The system stores completed graphical layers in a database. The system successively combines graphical layers associated to the same selected content into a track, which is further stored in the database. The system provides a user for tracking a selected user who so permitted while selected user is wondering and searching the World Wide Web. The system is provides the tracking user with graphical layers generated by the wondering user while he is observing a URL. Thereby the system generates a “virtual blog”. Namely the tracking user may observe the UGC introduced by the wondering user overlaid across the content which triggered the wondering user to introduce this very UGC. The system automatically searches the database for content related to the selected content thereby providing the user who selected the content for receiving a picture of what the users other than her or his collaborating colleagues think about the content that he has selected.

This application claims priority under 35 U.S.C. §119(e) to U.S. Provisional Patent Application 61/272,625, filed on Oct. 14, 2009, entitled SYSTEM AND METHOD FOR REAL TIME COLLABORATION AMONG A PLURALITY OF USERS IN CONSIDERATION WITH A COMPUTERIZED APPLICATION, the inventors of which are Dror Yaffe and Gilad Cohen.

### FIELD OF THE INVENTION

The present invention relates in general to systems and methods providing Software on Demand or Software as a Service (SaaS). In more particular the present invention relates to an engine providing for generating and managing a communication calling for and conducting an on-line collaboration is among a plurality of users considering selected computerized applications.

### BACKGROUND OF THE INVENTION

On-line collaboration conducted among a plurality of user in consideration with a computerized object is known. In US patent application the publication number of which is US20090132907A1a system and method for annotating web pages is disclosed. The disclosed method and system provides a user for generating an XML-based vector graphic annotation that is overlaid across a selected web page. Therefore a user who observes the graphical layer overlaid across a selected web page, is able to introduce his user content by highlighting selected text of the web page, adding notes such as by the keyboard of her or his user station; draw lines and drag the newly introduced graphical features to selected locations across the screen of the user station, such as by means of the mouse. The disclosed graphical layer such generated is transparent except for the new graphical features that are introduced by the user. Therefore this user as well as any other user who observes the same graphical layer overlaid on top of the same web page may collaborate by respectively introducing additional user content by modifying and/or editing the graphical features that were introduced previously. The disclosed system provides for automatically transmitting the changes introduced by one user to the other user.

In US patent application the publication number of which is US20090265607A1 a system and method for managing user content generated in consideration with the content of respective web pages is disclosed. The disclosed system provides a user with web-project folders in which he or she may store links to selected web pages and annotations added by this user to these web pages. A client application program provides a user with means to view the stored data in a selected web-project folder, means to add links to web is pages and annotations introduced in consideration with the respective web pages and means for managing the stored data. Therefore users may share their views and collaborate in consideration with selected content that is accessible in the World Wide Web.

Any improved means for on line collaborating in consideration with a computerized object, among a plurality of users, who are linked to the same communication network, that will provide users for conveniently responding to newly introduced user content and/or newly accessed or generated content, be it the output of a computer program that is just generated or a newly accessed document stored in a web site in the internet, any such improved means is beneficial.

### BRIEF DESCRIPTION OF THE DRAWINGS

FIG. 1 is a scheme showing the main components of a system for on-line collaboration according to an embodiment of the present invention;

FIG. 2 is a flowchart of a process in which data is transferred from the user station to a system server according to a preferred embodiment of the present invention;

FIG. 3 is a flowchart of a process for generating graphical layer by a user who has subscribed to the service.

### DETAILED DESCRIPTION OF THE PRESENT INVENTION

In accordance with the present invention there is provided a communication calling for on line collaboration and an engine for generating and managing such communication. A transparency like graphical canvas, sheet, or layer, referred hereinafter by the term graphical layer, provides according to the present invention a platform for such communication. A graphical layer according to the present invention is an XML-based vector graphic annotation is that includes annotations created and introduced by users and associated to a selected content, such as known. In US patent application the publication number of which is US20090132907A1, the content of which is hereby incorporated by reference, the features, structure and the procedure for generating of a graphical layer such as used in the present invention is disclosed.

The collaboration sought considers the selected content and involves at least two different users. The collaboration sought considers for example a computerized application that is currently operative in at least one user station employed by one of the users involved. Exemplary collaborating activities referred to by the present invention, in which a collaborating party is called to, or suggested to join, include according to the present invention but are not limited to: sharing, observing and/or discussing a computerized object such as text, graphics, a picture, a movie or a piece of multimedia, and/or reading a printed document. Any of documents associated with a URL that are normally displayed, such as by means of a browser, or are down loaded from, or generated by, a specific computer, such as a computer linked to a private network of an organization, are considered according to the present invention. Any computerized object that is currently observed by a user who is the first user, who further wants to add his own generated content, share it and/or discuss its content with his colleague or colleagues is considered as well. Further exemplary computerized objects include: a document currently edited by means of a word processor, such as MS Word®, by the first user who feels like discussing a related topic with another colleague; an outstanding phenomena observed by the first user while analyzing the outcome of a MS Excel® worksheet; an issue such as a problem considering timing of an activity or the level of loading of a resource that is required for carrying out a selected activity as reflected in a currently processed MS Project®; a design problem that is reflected in an output of a Computer Aided Design (CAD) application such as SolidWork®, and/or any selected content as reflected by a computerized application that is examined by the first user who wishes to share his views and/or discuss on line a related topic with his or hers colleagues. Any of such computerized objects either having respective URLs or those that are associated with an output that is normally displayed to the user across the screen of his or her user station are considered according to the invention. In a case that the object considered is not associated with an integral URL the system of the invention copies the output display into a file, such as having a Portable Document Format (PDF), save the copied file in a specified server and assigns a synthetic URL to the saved file. Such integral or synthetic URL provides for retrieving the file considered and delivering it to the collaborating parties. Such content which is selected by the first user to serve as the objective of the collaboration sought is referred hereinafter as selected content.

The system of the invention provides a user, who is the first user, for on-line sharing a selected content that is displayed across the screen of his, or her, user station with a colleague or a group of colleagues by means of a graphical layer. A graphical layer of the invention may include alphanumeric characters, text, graphics and/or pictures. The graphical layer may comprise transparent and/or lightly shaded, or colored and partially transparent segments, or contours, within which a user may place one or more computerized objects. The computerized objects may be any of the following: a media player to run a selected film or slide presentation such as prepared with MS Power Point® and/or a printed document, including the output of any computerized application that is formatted such as a PDF file. The graphical layer is overlaid as a transparency across the selected content across the screen of the user station of the first user as well as of those colleagues who so wishes. The graphical layer may cover a substantial segment of the screen up to its full extent. The selected content is displayed through the transparent segments of the graphical layer overlaid across it. The first user may shade selected zones across a generated graphical layer to focus the attention of spectators to a selected area within the page including the selected content to be shared. Similarly the user may designate selected zones across the layer for introducing additional computerized objects at a later stage.

In addition to the selected content which is the objective of the collaboration sought, a user may add to a graphical layer his or her own generated content. User generated content (UGC) according to the present invention is any of known computerized objects such as an object including text and/or graphics, a picture, a movie, a piece of music and/or a piece of multimedia, a selected section of a document and/or a section of an output of a common computer program as displayed by the user considered.

A graphical layer according to the present invention may comprise a number of mini-layers, or sub-layers. A user may edit a layer by incorporating one or more ready made mini-layers that have a specific layout and/or include specific graphical objects. A library including ready made sub-layers is stored in the system. Users may edit a new sub-layer that can be incorporated into the library.

The first user first activates the system to generate and edit a graphical layer and to introduce the selected content into the layer. A user who has subscribed to the service may add a one or more groups of different addressees each of which belong to one his social networks. In such cases the system automatically delivers the graphical layer to each of them. Otherwise the first user himself has to deliver the graphical layer to his colleagues, such as by e-mail. Completed graphical layer that has been stored in the database of the system will be displayed by the first user and the other addressees involved as a transparency overlaid on top of the selected content. The first user may differentiate among layers to be shared with different addressees. He or she may share one graphical layer with a group of selected addressees, whereas other graphical layers that contain the same selected content but include different user generated contents may be shared with different subgroups of the first group or other independent groups of addressees. (Subgroups referred hereinafter include a number of addressees, or only one addressee.)

The first user may use a “whistle” layer that is associated to the selected content and is automatically delivered by the system of the invention to a selected group of other users for calling their attention to the selected content. The whistle layer further provides the first user for starting a “collaboration is session” (either online or offline) with them orally and/or in writing, in consideration with the content displayed. Software module for operating voice over internet is also considered as a computerized object that can be incorporated into a graphical layer of the invention. The first user may further activate various activities that involve different layers to be associated with the same selected content. Additional exemplary layers according to the present invention are: (i) a graffiti layer in which the first user may add any kind of computerized objects including his own generated graphics drawn on top of existing printed objects; (ii) a talk-back layer that is addressed to a specified group of addressees in connection with what these addressees are currently doing. The content of a talk-back can be further retrieved and presented to the participating parties as well as the subjects discussed; (iii) a layer including links to “subject related” URLs the content of which is automatically found by the system to be relevant to the content originally selected by the first user; (iv) a layer including “related films”, for example films having URLs such as films stored in YouTube® the content of which was automatically found by the system related to the content originally selected by the first user; (v) a layer including a personal message issued by the first user to be presented by surprise to an addressee who is automatically ambushed by the system at a selected website. In addition to simply calling the attention of selected colleagues, the resulting interaction according to the present invention between the first user and any of his collaborating colleagues may therefore depend on what web-site the colleagues presently visit, or what is the content they are presently viewing. The layers according to the present invention provide a user for creating content anywhere, at any time, spread it among selected colleagues, let them know, collaborate such as by discussion and further forward a generated content to other addressees.

User generated content (UGC) according to the present invention is any of known computerized objects such as an object including text and/or graphics, a picture, a movie, a piece of music and/or a piece of multimedia, a selected section of a document and/or a section of an output display of a common computer program as displayed by the user considered. Such an object can be added to a layer introduced by the user and associated with the is selected content.

The system of the invention successively combines the various graphical layers including the link to the same selected content (those introduced by the first user as well as the graphical layers introduced by any of the addressees as a response to the originally sent first graphical layer) into a track. The system archives these tracks which includes all the graphical layers successively generated starting from the original call for collaboration in the system database. A track includes the selected content that has either an integral, or synthetic URL, or a series of layers each of which includes the layers associated to the same selected content by the first user and/or any of the addressees at successive points in time while a collaboration session goes on. A batch of layers associated with the same selected content that is generated at one point in time is defined hereinafter as a scene. Therefore the user and/or any of his colleagues can retrieve a series of scenes each of which includes the graphical layers that are associated to the same selected content and represent them. While reexamining sessions stored in the database a user may skip among some of the scenes, choose a scene or a number of scenes which he may further modify and/or edit some or all the associated layers, associate it to the same or another selected content and share the new package with the same or other addressees as another scene in the same collaboration session or to start a new session of collaboration.

The system provides a subscribed user with a repertoire of communicating functions. For example, a user may “whistle” or teas one or more users by inviting them to collaborate in assessing the selected content. Alternatively, a user may ambush one or more other users at a selected web site, such as a specific URL or at a selected site in a private network of an organization. The system automatically retrieves the selected content and the associated layers and notifies the addressee or addressees when they first get to the ambush site that a graphical layer is waiting for them. The system further provides an addressee with an option to automatically follow the first user wile he or she is browsing or searching among specified contents that are accessible to members of the network considered and/or while the first user is browsing the is World Wide Web.

Obviously the first user who initiates a collaboration session has to be, at least momentarily, linked to the system of the invention. Linking is automatically accomplished by means of the client framework that is resident in the system server. A user need not down load the client framework to his or her user station. Such linking can be manually activated when the first user access the system of the invention such as by a bookmark saved in his list of favorites of his browser. Alternatively, such linking is automatically activated when a user tries to edit a graphical layer that was previously e-mailed or on-line delivered to him by the system. User who downloads the client framework to his user station is thereby subscribed to the service. The system is automatically linked to the user station of a subscribed user when the user turns on his or her user station. However in cases in which the group of addresses was selected from social networks of the first user, any of the addressees considered need not be linked to the system at the point in time in which the collaboration is initiated. The system stores all the system calls for the collaboration considered and specifically indicates in the database the accomplished activities as specified by the respective graphical layer in consideration with any of the addressees. Any system call that is waiting to be accomplished, be it a time dependant activity, such as a request to deliver a user with a whistle or graffiti layers, or a site dependant activity such as ambush, that concerns a user who is currently not active, is automatically taken care of the first time in which the system identifies that the user station considered is active and therefore this user is able to recognize that he or she has been addressed with such a call for collaboration.

The system of the invention provides a user with tool kits providing for generating any of the aforementioned graphical layers in which a text and/or a computerized object can be inserted. A list of tool kits that are currently available as well as list of functions and/or activities that are available to a user at a given point in time is presented to the user by his request, as known. Graphical tool kit provides a user for drawing graphics such as generated by Paint®, or Paintbrush®. Such graphics can be added by the user on top of a graphical object, such as drawings generated by SolidWork®, a slide presentation is prepared by means of MS Power Point®, a graph generated by MS Excel®, or a gantt-chart generated by MS Project®.

An engine for generating and managing communication concerning on-line collaboration according to the present invention includes an application server, or a cluster including a number of application servers, all of which are connectable to a plurality of user stations by means of communication network. Varieties of computer networks are considered according to the invention, exemplary are wired or wireless, LAN, WAN, intranet, and/or the internet. The user stations considered are any of the known personal computers such as desktop computers, laptop, hand held computers known as PDAs, or mobile phones of the third generation providing e-mailing and/or for browsing the World Wide Web. The engine or the system of the invention can be adapted to be incorporated into a private network of an enterprise, by employing a dedicated server or servers and dedicated software modules to be respectively installed within user stations and these servers. Alternatively a dedicated web site in the internet provides for accessing the system similarly to accessing web sites providing common Software as a Service (SaaS) applications. Obviously remote system servers that are connected to the internet can be employed for providing a service of on-line collaboration according to the present invention to and among members of an organization. In such a case linking any user station employed by a member of the enterprise is automatically accomplished by the client framework of the system of the invention as further described infra. In such cases a user as well as any of his collaborating colleagues who are members of an enterprise, or organization, is automatically responded by the remote system servers as if the servers are integrally connected to the enterprise network.

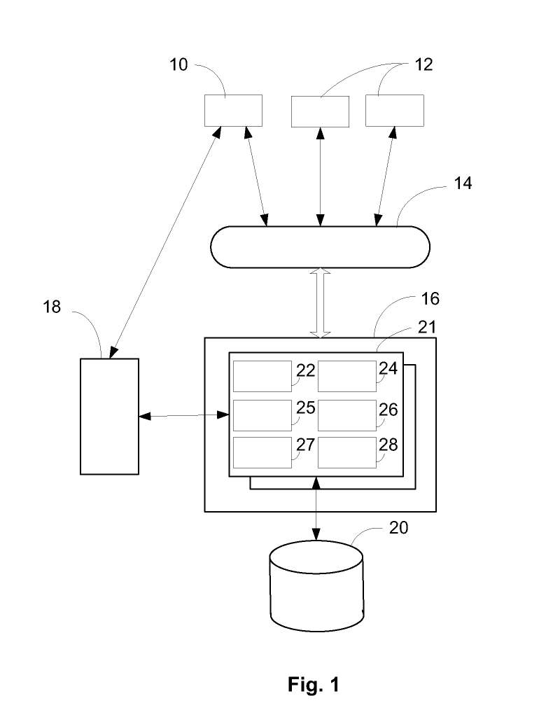

Reference is now made to FIG. 1 in which a scheme showing the main components of an engine or system for generating or initiating and managing communication concerning on-line collaboration according to an embodiment of the present invention is shown. A plurality of user stations 10, 12 is connectable through computer communication network, not shown, to proxy server 14. Proxy server 14 provides for securing the computer system, such as by firewall, is caching data, balancing the load among, and managing the operation of the servers of the system cluster 16, such as by adding servers to work in parallel at stages of high load, as known. Proxy server 14 can be implemented such as by means of Apache proxy server. Server 18 is an exemplary server connected the computer network considered that is connected to the internet for accessing data and/or computer resources that are available to a user browsing the World Wide Web. Database 20 provides for at least archiving tracks as described hereinabove. System server 21 which is one of a number of identical servers each of which connected to database 20, includes a number of modules such as commands generator 22 for generating system commands written in AJAX. Layer manager module 24 includes respective sub-modules of a client framework that provides an un-subscribed user for manually activating functions of the system. Downloading managing module, not shown, provides for downloading a client framework to a user station of a subscribed user, or providing an unsubscribed user for activating widget manager and downloading selected widgets upon user's requests. UGC manager 24 provides for accessing the relevant data and generating and associating metadata to the selected content, such as URLs and/or domains in the World Wide Web that are accessed. User manager 25 and UGC manager 24 modules provide for sensing the presence of a user in a given domain and tracking him or her while is wondering across the World Wide Web. The system automatically tracks only subscribed users who has approved their being tracked. Upon subscribing the user is asked by the system if he agrees to being racked. The user can specify domains that he does not allow to be tracked in case he or she accesses these domains. Additionally a user may specify domains which he agrees to be tracked while visiting them. Therefore the above mentioned tracking is accomplished only for user who allowed tracking wherever these users have speciified. Automatic tracking Site/note module 26 by which for example ambushing is initiated and talk back module 27 provides for generating and managing talkbacks. Notifier 28 provides for managing and triggering alerts automatically given to the users.

For operating the system of the invention a user need not be registered or subscribed to the service. For subscribing to the service provided is according to the present invention a user has to download the client framework resident in server 21, such as by accessing the web site of the service provider. Registering to a system servicing an enterprise can be accomplished by the respective administrator. The administrator also takes care of security issues such as approving a list of potential collaborating colleagues to a user considering a specific content, or a range of contents in accordance with the security level of the respective members of the organization considered. Alternatively, a user is automatically registered to the service the first time he accesses the web site of the service provider in the internet and downloads the client framework to his or her user station. User who does not want to download the client framework to his user station can be linked to the client framework that is resident in the system server, through the web page of the service provider. Such user may store a bookmark of one of the toolbars each of which enables him or her to generate and edit a specific type of graphic layer and to introduce the selected content into it. Such user will have to personally deliver the graphical layer to his selected colleagues, such as by email. Nevertheless, the system will automatically save the completed graphical layer and will keep track of all the graphical layers that will be further generated and/or edited by responding addressees as long as the first user is linked to the system.

A subscribed user of the system of the invention is uniquely identified by the system by means of a username, password and associated identifiers, such as email address, an identifier of a unit of the organization to which this user belongs, as the number of the department within an organization, or the social network in which the user is registered. Upon registering a user is asked to assign himself or herself a password that allows him or her to retrieve data that is stored in the system database. A client framework that provides for operating the system by means of a user station is manually downloaded by the user approval, and automatically installed among the program files within his user station. At this stage the system automatically looks for example for the list of members of the same social network, such as Facebook® or Twitter®, that are grouped as colleagues of this user, designating them as potential addressees for future collaborating sessions. A user that belongs to a number of social networks may have independent different identities. Optionally the system is of the invention may upon specific request of a user, merge among different lists of colleagues as reflected by the respective social networks.

A generated graphic layer is uniquely identified by the system of the invention at least by the physical address of the user station of the user considered, the time of its generation and the selected content. Therefore an automatically associated URL can provide for technically accessing and retrieving this layer at least as long as the user who has just generated this layer remains linked to the system. Metadata associated with the graphical layer includes further annotations and identifiers for the selected content that are automatically introduced by the system. Identified graphical layers are stored in the database. A graphical layer that has been generated by a subscribed user remains identified by the system along a predefined time interval even after the user generating this graphical layer has turned off his or her user station. Additionally terms that are associated to a selected content that has an integral URL, or that are generated by means of a contextual analysis of selected contents that is associated with a synthetic URL are also included among the information associated as metadata to the selected content. Such terms are used by the system when the UGC manager module searches the graphical layers stored in the database for related content. The outcome of such searches provides a picture of what users that are different from the collaborating parties of the user considered think about the content he has selected.

For example the user employing user station 10, who is also referred hereinafter as the first user or whistling user, has downloaded a document from server 18, a section of which he finds outstanding. (Server 18 may be a specified server in a private network or any server that hosts a specified web site in the internet or a URL.) The first user may wish to share his views considering this outstanding content with some of his colleagues each of which independently employs a user station such any of stations 12. For this purpose the first user activates the client framework of the system of the invention that is resident in user station 10. The client framework of the present invention is a browser like software application. The first layer is automatically opened and the selected document is automatically linked to this layer when a dedicated icon located among the system icons of the user station is double clicked.

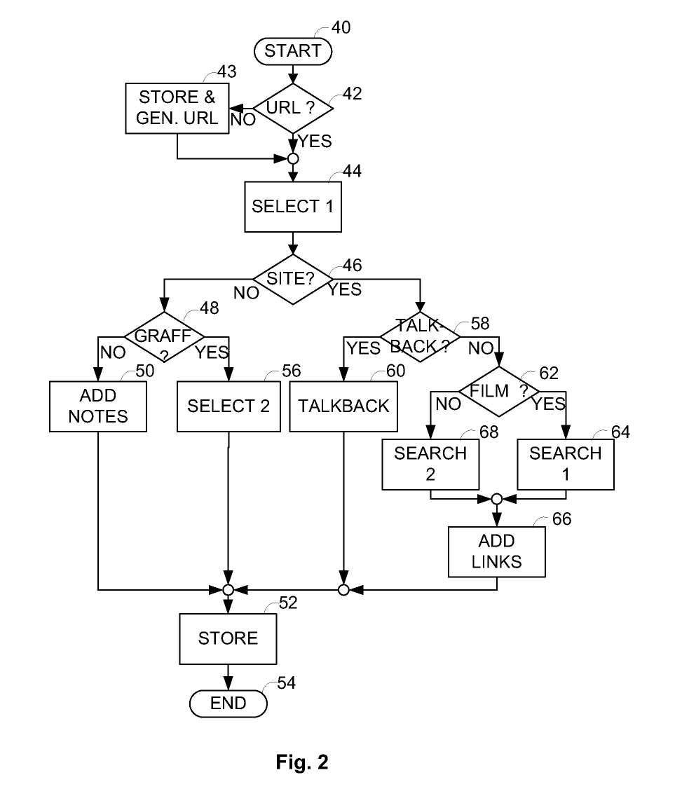

Reference is now made to FIG. 2. In FIG. 2 a flowchart of a process in which data is sent from the user station to the system servers and databases according to a preferred embodiment of the present invention is shown. The process starts in step 40 when the user who has decided to share the content currently presented across the screen of his station with other users of the system indicates the specific content by double clicking across the system icon. Any user accessing the system is automatically listed by the operating program of the system as being active. A notifier which includes a timer such as implemented by means of a watch dog mechanism, provides for keeping the list of active users updated. In step 42 the program checks whether the content shown across the screen of the user station is associated with a URL or whether it is an output display of an application program that is currently operative in the user station. In a case that the displayed content is not associated with a URL a printout of the screen is automatically generated and saved in step 43 in one of the system servers. A synthetic URL is automatically assigned by the system to the saved file. The format of the saved file is such as any of the known “bmp”, “JPEG” or a “PDF” files. In step 44 the user manually selects the very type of a layer he wishes to generate. Namely, the user may select to generate a whistle, or graffiti which are user dependent layers and that are site independent layers, otherwise the user may choose to generate site dependent layers such as for ambushing a specified user or users at a certain network domain or a URL. The site related layers may include according to the present invention a list of subject related objects or films. The user is further automatically provided with a list of his potential addressees, such that he may select listed addressees out and/or add addressees as he wishes, such as by filling in user names and email addresses.

In step 46 the operating program installed in the server checks whether the layer is site dependent or not. In a case that the user has selected to generate a layer that is user dependent and site independent the program continues in step 48 to check whether a simple whistle or graffiti is selected. In a case of a whistle the user may add only a note in step 50. In step 52 the data related to this whistle is stored in the database, the graphical layer is assigned with a URL and the process ends in step 54. Otherwise in a case in which graffiti is selected in step 56 the tools providing for introducing objects into a layer become available to the user such that he is able to incorporate whatever objects he chooses including pictures, movies, textual objects, and/or draw graphics on top of printed documents, by means of the graphical tool box. At the end of step 56 the program automatically continues to step 52 in which the data related to the generated graffiti layer is stored in the database and the graffiti layer is assigned with its URL. In a case that the first user chooses to generate a layer that is site dependent the program checks in step 58 whether the layer to be generated is a talkback layer. In such a case a structure providing for talkback is incorporated in the generated layer in step 60 in which a note authored by the first user can be also added to the layer and the program further continues to step 52. Talkbacks are saved in the database in consideration with their authoring parties as well as with the content that originated the collaboration session considered. Any user of the system may ask for receiving all talkbacks in which he himself has participated as an author or talkbacks related to a specified subject.

For suitably responding a user who chooses to share with his colleagues additional content referring to the same subject of the collaboration considered, such as papers or films each of which has a URL, the program checks in step 62 whether the user has requested to search in the database for related films. Such search is automatically carried out in step 64, whereas searching for related documents and/or objects other than films, is carried out in step 68. Both above mentioned options provide a user with the ability to learn what other users who are not members of his group of addressees think about his selected content. Contextual analysis related to the subject matter observed by the first user is automatically carried out by the UGC manager module of the system, as known, whenever a selected content is been indicated by any of the users. An automatic search of the database for content related to the selected content that is based according to the method of the present invention according to the terms resulted from such contextual analysis. An automatic search for is related content can be also initiated by a user request in consideration with any received graphical layer, such as a talkback. By the end of any of these automatic searches the links to the objects that were automatically found are automatically introduced to the respective layer in step 66 by the end of which the program automatically continues to step 52.

A user, who has not subscribed to the service and yet wants to generate a graphical layer and take advantage of the managing capabilities provided by the system of the invention, may activate an “edit” widget that can be accessed by means of a widget activating the widget managing module that is always included in a graphical layer that has been automatically forwarded to him previously. Alternatively this user may click on a respective bookmark that was previously saved in the list of favorites of his browser. Clicking such bookmark or widget which any of which invokes a client API of edit by which a document object model (DOM) is opened and provides him with a selection of editing capabilities. The user is able to choose among some suggested widgets presented to him by means of a widget manager that is installed in the system server. The bookmark of the widget manager is always automatically added to the graphical layer by the system. Therefore an edit widget can be accessed by anyone who opens a saved graphical layer. By double clicking the widget manager is opened and presents to the user a selection of widgets that are currently available to the user. Double clicking on a selected widget the widget manager installed in the system server downloads the respective API to the user station. The user first opens the computerized object; say a URL which is his or her selected content to be discussed with his colleagues, By double clicking this opened URL the system automatically records a link including the respective address in the newly generated layer. The user may invoke for example a “comment” widget, by which the system provides him or her with an option to designate, such as by means of the mouse, a location across the screen where the text that he or she is going to enter by means of the keyboard is to be placed. By selecting among some “paint” widgets that are presented by the system the user may choose for example the “pencil” that will allow him or her to draw free lines and/or insert alpha numerical characters in handwriting by means of the mouse. Similarly by choosing “brush” the user may color selected is geometrical shapes that he first has drawn by means the pencil or has download from the graphical library that is opened according to his decision. Suitably sizing the geometrical shapes can be achieved by means of the mouse. The user may save the completed graphical layer by selecting and clicking on “save” widget that is presented to him among other widgets that are available to a user. By double clicking the “save” widget the system saves the graphical layer that further has a metadata annotation that specifies the activation parameters for displaying the saved layer when it will be further requested by this user or any of the addressees. The system identifies graphical layers generated by an un-subscribed user as long as the authoring user remains linked to the system. Therefore this first user may either email his colleagues or identify him to the system by starting a session of identification. Starting such identification transforms the first user from a visitor to a subscribed user when the user provides identification info such as specifying his email address and/or his social network and designates his group of colleagues who are members of the same social network. This user may further activate the delivery function by which the system will automatically deliver the generated graphical layer to the specified addressees.

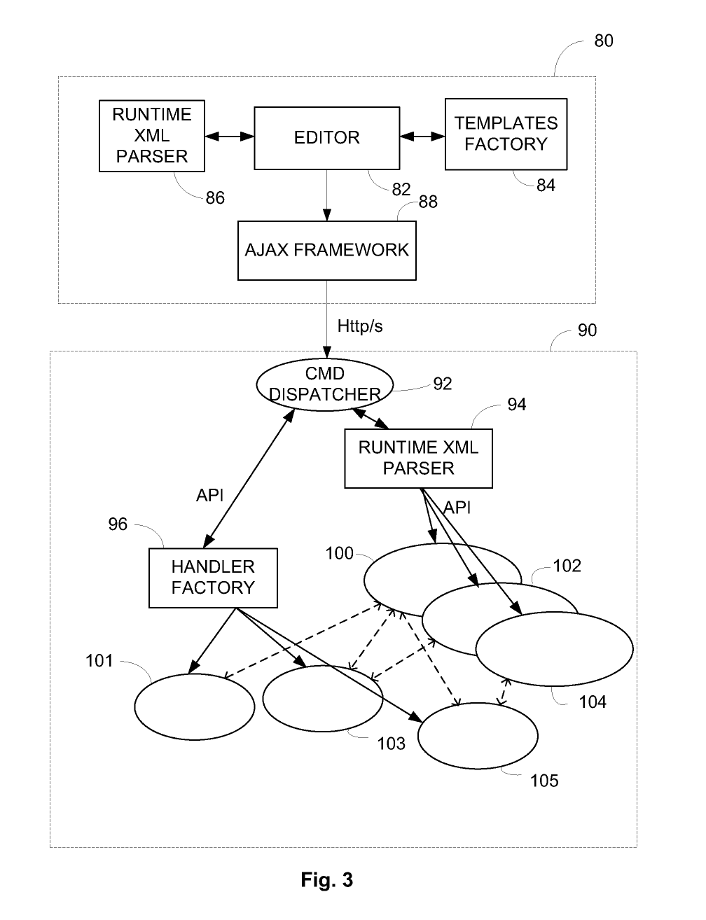

For the sake of software and system scalability commands sent to or from the client framework and/or any of the system servers consist of templates or design patterns as can be seen by reference to FIG. 3 which is now made. In FIG. 3 a process for transmitting command from the client framework to the system server according to a preferred embodiment of the present invention is shown. Command framework 80 installed at a user station is updated according to a preferred embodiment of the method of the present invention whenever the user starts using the system. Updating is accomplished by an automatic downloading the current version of the command framework from a respective system server. The protocol employed for communicating among servers and user stations comprises a user layer that includes text written in XML format incorporated over a layer of http/s. The client framework is a FLASH client using AJAX to invoke and handle the protocol. Command framework 80 includes editor 82 that select a ready made template suitable for the specific request is considered that is stored in template factory 84. Editor 82 further uses XML parser to include the specific parameters of the considered command. Then by means of AJAX framework the respective user layer is transmitted to the server according to the http/s protocol. Such edited transmission is further transmitted to command framework 90 that is installed at a respective system server. The server is implemented in Java that uses network socket to listen to commands (represented in XML) invoked by the client. Data related to users such as pointing out the identity of a user who has been addressed with a whistle to update managing module 100 by means of command handler 101. For example, details regarding user generated content which is included in a graffiti layer is indicated to User Generated Content managing module 102 by means of command handler 103. Command handler 103 is further related to user managing module 100.

Normally the user initiating a collaboration session, who is the first user, calls the attention of one or more of his colleagues by sending them a whistle or a graffiti layer. When a user first accesses the system the operating program checks in the database whether any whistle or a graffiti layer is waiting for being delivered to this user. Furthermore, whenever the user managing module is referred to a user, the operating program similarly checks whether graffiti or a whistle layer are waiting to be delivered to this user. In cases in which a layer is ready to be delivered to a user, the operating program of the system of the invention first alert the user and delivers an extract including identifying data related to the addressed content including the URL and the identity of the sending party to the respective user station. Any addressee of a whistle or graffiti layer may identify the calling party, such as by pointing the mouse across the icon thereby the username of the calling party is automatically displayed. Then in a case that the receiving party so chooses he or she may open the graphical layer, such as by double clicking the icon indicating a received whistle or graffiti. Such opening causes the operating software of the system of the invention to automatically download the referenced document by employing the URL as recorded in the database. Similarly the additional content generated and/or introduced by the first user is automatically overlaid as an additional layer on top of the opened document. The additional content is is designated by icons and/or labels differentiating among various objects, such as those including a note, textual object and/or a piece of multimedia. Double clicking the label or icon activates the opening of this object.

The operating program of the system always tracks a browsing user by means of the user managing module that is installed in a server of the system for detecting whenever a new domain or URLs are accessed. The client framework automatically notifies the system server whenever new domain or URLs are accessed. Such notification is accomplished by means of command handler 105 that is linked to user managing module 100 as well as to content and semantic managing module 104. Accessing the new URL or domain is recorded in the database. Additionally, the operating program installed in the system server automatically checks whether any of site dependant layers, such as ambush layer, layer including a searched content and or film and/or a talkback layer, is waiting to be revealed to this user at the domain or URL considered. In a case that indeed such layer is waiting the identifying data is downloaded to the respective user station upon the request of the respective user. The receiving user may if he so wishes to see who the calling party is and further open the waiting layer, thereby causing the operating program to download the basic as well as all the additional layers that were waiting for him at the site he or she has just accessed.

A receiving party may choose to respond by ascribing new content to the same layer which is automatically addressed to all originally listed addressees and the first user among them. The operating program of the system of the invention associates the first scene of any collaboration session with any successive responding scene to a track. Such a track is characterized with chained scenes, each of which identified according to the identity of the user generating it and the time in which it is generated. A receiving party may independently choose to transmit a new whistle that initiates another collaborating session, to continue the collaboration session by responding the scene received last, and/or to quit the current collaboration by not responding to the last scene received.

Graphical Tool Kit

A user of the system of the invention may generate a graphic layer that includes two dimensional vector presentations of geometric features including specified colors. The features normally available to the user include for example a pencil for generating free lines, a fine and coarse brush, a roller which provides for coloring inside contours and special graphic features such as linear and arcuate lines and basic geometrical shapes including a library of some ready made geometrical shapes as well as some ready-made drawings.

Automatic Search

The system automatically identifies subjects of interest, such as known, by analyzing explored pages having URLs along an exploration session that is carried out by a user. Therefore the system may recommend a user with a list of films, such as those available in YouTube, multimedia pieces and or documents considering related subjects all of which having a URL that are available in the network and are capable for being downloaded from the respective web sites within the network. The URLs of such objects of interest are automatically introduced into a content related layer that includes auxiliary data related to the selected content, which is further stored in the database, such that it is linked with the user who generated the layer as well as with the respective addressees. The system retrieves and presents a list of the recorded content to the users considered and upon the respective user request downloads the content related layer including such content to the user stations considered, whenever any of these user accesses predefined web sites of the network. Thereby a user of the system of the invention is privileged to learn the opinions of users other than his collaborating colleagues considering the subjects he is interested in. Exemplary content related layers include analyzing reports considering a specific company or a specific share associated with a is user who is exploring websites dealing with the stock exchange market.

Additional Features of the System of the Invention

A user may limit the publicity of content generated by her or him upon subscribing to the service. For example such user may choose that any content that he generates can be publicized. Nevertheless, subscribed user may set the privacy level of a newly generated graphical layer. A classified graphical layer as well as the graphical layers that are sequentially responding to, or resulting, from this layer is limited only to the addressees that were originally designated by the first user. The first user may update the list of addressees who are eligible for receiving such classified graphical layers at any collaboration scene following the first scene when the first graphical layer was generated. Classified graphical layers are not included in a layer of related content following a search that was initiated by a user who is not eligible for receiving these layers.

Subscribed user of the system of the invention may choose to surprise one or more of his colleagues by delivering them a selected content while they are entering a predefined web site or domain. The ambushed member is automatically identified by the system which starts tracking him when he first turns on his user station. The purpose of such tracking is to enable the system to immediately notifying him or her that a graphical layer associated with content selected by one of his or her colleagues is waiting for him or her to be opened. Optionally the system of the invention automatically ambushes any user who is associated with a talkback layer at sites that are automatically selected by the system in accordance with the subjects of interests that were identified during the automatic search associated with this very user. For example the user described above who is interested in the stock exchange market will be ambushed at predefined website of the company considered or at a website that deals with news from the stock market. Alternatively the user who is looking for books or papers dealing with the respective subjects can be ambushed at a website of a book store.

Another feature of the system of the invention is in a way similar to the “follow me” activity such as provided by Twitter®. A user of the system may request to track another user namely, to receive graphical layers that are generated by another user of the system. Such request is accepted by the system conditioned that the tracked user has previously agreed that any of the graphical layers generated by him or her can be publicized. In such case, the system of the invention automatically alerts the requesting user whenever a graphical layer generated by the tracked user is accomplished and is ready to be retrieved. Alternatively, a user of the system may invite any other user who is interested to follow him and view the content of a “virtual Blog” that consists of a series of graphical layers including content authored by the inviting party. These layers are successively generated by the inviting party while he or she explores the World Wide Web whenever he visits a selected domain and observes and/or analyzes a selected URL. Such virtual blogging is automatically generated by the system while the inviting party explores the World Wide Web. The inviting party may publicize in the web site of the service provider a call to who ever uses the system to join him while he is exploring the World Wide Web. The system of the invention automatically considers all the members of the group or groups associated and/or organized by the inviting party in any of his or her social networks as users who follow the exploring party. Any user who starts using the system at any point in time within the specified time frame is automatically announced by such option. A user who accepts the invitation and wishes to join the guided tour along its full track and so requests is automatically presented with the graphical layers one by one as they are generated by the exploring party overlaid across the same URLs addressed by the inviting party. Presenting of the graphical layers considered is synchronized by the system such that both the inviting party and any of the users accepting the invitation are simultaneously presented with the same layers overlaid across the respective pages almost at the same time.

Alternatively, a user accepting the invitation to join a guided tour is able if he so wishes to be alerted by the system whenever a new graphical layer is generated by the exploring party. In such a case the system of the invention automatically alerts in real time a user that so wishes about a new graphical is layer that has been added to the virtual blog considered. The user may open any of the graphical layers of this virtual blog at his convenience at any time within a given time frame that is also publicized in the web site of the service provider. The inviting party may if he so chooses to introduce in addition to just commenting also other type of user generated content and add it as a graffiti layer on top of the content that he has just examined. All the following users are presented as described hereinabove by such graffiti layers including the additional content whenever such content is generated and/or by their special request. A track including all the pages that were visited by the inviting party including all the graphical layers and the additional graffiti layers as were successively introduced along the guided tour is automatically recorded at the database of the system. Such virtual blog of specified guided tours or specified guides can be retrieved by any user of the system at any time within a predefined time interval that follows the time of the invitation to the guided tour.

In addition to the alerts automatically given by the system to ambushed users when they access the specified domain, or to user that has been addressed by a communication while her or his user station was turned off, the system of the invention automatically alerts any member of a forum or a group of members of a social network whenever a new graphical layer is generated by the group moderator. Any user receiving such alert is able to retrieve according to her or his convenience, at any time within a given time frame and access the graphical layer considered as is saved in the system database. The system automatically alerts members of forums and/or groups of members in cases of newly generated graphical layer by any of the members of the forum or group in cases in which the convention of the forum or group is such that a user content that is generated by any of the members of the forum or the group can be publicized. The system automatically alerts on-line the users who are currently linked to the system. Additionally, the other forum or group members are automatically alerted by an email indicating the newly generated graphical layer.

Access to a recorded track is approved by the system to the users who took part in any collaborating session at least as passive listener. Any of these is users may start an independent collaborating session based on any of interim contents of such recorded session. A user may retrieve a recorded track by identifying himself with his username and password. He then may edit any selected interim content to initiate a new collaboration session. An interim content is any of the graffiti layers that include objects such as responding text messages and/or any content that the first user or any respective addressee. Scrolling among the various objects that are introduced along a session can be accomplished by any of the participants of a collaborating session. Such scrolling causes the various introduced objects to successively open and displayed across the screen of the user station considered.

Optional Applications

A user who so wishes may be presented by the system of the invention with talkbacks and/or tips considering a subject that is one among all the previously selected contents that were chosen by any of the users who has previously used the system. Similarly talk backs or tips considering a product that has been discussed or described in any of the previously stored contents as turns out from the analysis of an exploring history of a selected user, are presented to the requesting user. A user of the system is privileged to observe talkbacks or receive tips considering a selected issue at any time and/or anywhere across the World Wide Web, not necessarily at dedicated chat rooms and/or specified blogs.

Advertising and/or sales promotion can be easily integrated in addition to the “virtual blogging” function. The service provider may expand his user groups by offering revenue sharing to selected opinion leaders or moderators of forums and/or member groups as an incentive for creating more virtual blogs, organizing more guided tours and extending the group of participants in his or her guided tours.

1. A system for generating and managing communication by means of graphical layers, wherein said communication takes place between at least two users, and wherein said communication concerns on-line collaboration in consideration with a selected content, and wherein said system comprises a proxy server for receiving and transmitting said graphical layers, and wherein said proxy server connectable to at least two user stations by means of a communication network, the at least two user stations operated by said at least two users respectively each, and wherein said proxy server further connected to at least one system server for managing said communication, and wherein said at least one system server connected to a database for storing at least one of said graphical layers, said system comprising:
a user generated content (UGC) manager for searching said database for content related to said selected content;
a layer manager for successively combining graphical layers generated by said at least two users into a track, and
a notifier for alerting one of said at least two users, who is the first user, when a graphical layer generated by the second of said at least two users, which is the completed graphical layer, is ready to be retrieved from said database.

2. A system such as in claim 1, wherein said at least one system server directly connected to said communication network.

3. A system such as in claim 1, wherein said at least one system server connected to the internet.

4. A system such as in claim 1, wherein said completed graphical layer comprises graphical features, and wherein said layer manager operative in incorporating a widget providing for modifying a graphical feature into said completed graphical layers.

5. A system such as in claim 1, further comprising a user manager which is operative in tracking an active user browsing the World Wide Web.

6. A system such as in claim 5, wherein said completed graphical layer comprises a link to a domain in said communication network, and wherein said domain designated by said second user, and wherein said alerting automatically effected when said first user accesses said designated domain.

7. A system as in claim 1, wherein said selected content associated with a URL.

8. A system as in claim 1, wherein said layer manager operative in assigning synthetic URL to said selected content.

9. A system for generating and managing communication by means of graphical layers, wherein said communication takes place between at least two users, and wherein said communication concerns on-line collaboration in consideration with a selected content, and wherein said system comprises a proxy server for receiving and transmitting said graphical layers, and wherein said proxy server connectable to at least two user stations by means of a communication network, the at least two user stations operated by said at least two users respectively each, and wherein said proxy server further connected to at least one system server for managing said communication, and wherein said at least one system server connected to a database for storing at least one of said graphical layers, said system comprising a link to the internet, wherein said at least one system server operative in carrying out an activity selected from a group of activities consisting of:
tracking at least one of said at least two users, who is the first user, while said first user explores the World Wide Web,
searching said database for content related to said selected content,
alerting the second user of said at least two users when a graphical layer generated by the first user, which is the completed graphical layer, is ready to be retrieved from said database,
recording links to domains in the World Wide Web accessed by said first user in said database,
successively combining graphical layers generated by said two users into a track,
combining a virtual blog, wherein said virtual blog comprises at least said completed graphical layer, and
any combination thereof.

10. A system as in claim 9, wherein said at least one of said graphical layers comprises graphical features, and wherein said at least one server stores a number of widgets, and wherein said at least one server further operative in incorporating one of said widgets into said at least one of said graphical layers, wherein said widget provides for modifying a graphical feature of said at least one graphical layer.

11. A system such as in claim 9, wherein said alerting automatically effected when said second user accesses a domain in said communication network, and wherein the link to said domain in said communication network recorded in said completed graphical layer.

12. A system as in claim 9, wherein said selected content associated with a URL.

13. A system as in claim 9, wherein said at least one system server operative in assigning synthetic URL to said selected content.
